(19) United States
(12) Patent Application Publication
(10) Pub. No.: US 2021/0095163 A1
(43) Pub. Date: Apr. 1, 2021

(54) DOUBLE-SIDED TAPE AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Yifu CHEN, Beijing (CN); Ting DONG, Beijing (CN); Lingdan BO, Beijing (CN); Yingying QU, Beijing (CN); Zhihua SUN, Beijing (CN); Jianhua HUANG, Beijing (CN); Zhiyu LV, Beijing (CN)

(21) Appl. No.: 17/039,269

(22) Filed: Sep. 30, 2020

(30) Foreign Application Priority Data
Sep. 30, 2019 (CN) 201910951735.5

(51) Int. Cl. C09J 7/26; G02F 1/1335; G02F 1/1333

(52) U.S. Cl. CPC C09J 7/26; G02F 1/133512; G02F 1/133308; C09J 2203/318; G02F 2001/133314; C09J 2301/16; C09J 2301/1242; G02F 2202/28

(57) ABSTRACT

The present application discloses a double-sided tape and a display device. The double-sided tape includes a first adhesive surface and a second adhesive surface disposed oppositely in a thickness direction; and at least one of the first adhesive surface and the second adhesive surface of the double-sided tape is provided with a plurality of recesses.

### CROSS-REFERENCE TO RELATED APPLICATION

The present application claims priority from Chinese patent application NO. 201910951735.5 filed to China National Intellectual Property Administration (CNIPA) on Sep. 30, 2019, the disclosure of which is incorporated herein by reference.

### TECHNICAL FIELD

The present disclosure generally relates to the technical fields of adhesive tapes and display, and particularly relates to a double-sided tape and a display device.

### BACKGROUND

With continuous development of the display industry, the bezel-less display technology has become a mainstream direction for the development of the display field. Typically, a display screen includes a display area and a surrounding opaque non-display area, the opaque area being located around an outside of the display area. Display panels of conventional bezel-less displays are adhered and fixed onto the bezel via a black double-sided tape below the non-display area. This tape has a strip sheet shape, and a rectangular cross section. During adhesion, this tape will produce stress under the influence of factors such as self-deformation of the tape, fluctuations in the fitting precision, flatness of the module bezel at a support position, deformation of the module bezel, or the like, leading to accumulated stress in the non-display area at edges of the screen. When the stress becomes too large and cannot be released effectively, it will be transferred to the display area, causing a light leakage defect at edges of the display area in a dark state and thus affecting display quality of the product.

### SUMMARY

The present application provides a double-sided tape and a display device that can realize absorption of the stress and avoid the problem of the light leakage defect at edges of the display area in a dark state.

In a first aspect, there is provided a double-sided tape, wherein the double-sided tape includes a first adhesive surface and a second adhesive surface disposed oppositely in a thickness direction; and at least one of the first adhesive surface and the second adhesive surface of the double-sided tape is provided with a plurality of recesses.

Optionally, each of the plurality of recesses has an opening in a thickness direction and a width direction of the double-sided tape, wherein the opening of each recess, in the width direction of the double-sided tape, is open to at least one side of the width direction, and the double-sided tape extends in a length direction.

Optionally, each of the recesses has an orthographic projection of a triangle shape in the thickness direction, one side of the triangle is the opening of each recess in the width direction of the double-sided tape, and the plurality of recesses are arranged in a spaced and staggered manner in the length direction of the double-sided tape.

Optionally, each of the recesses has an orthographic projection of a rectangle shape in the thickness direction, one side of the rectangle is the opening of each recess in the width direction of the double-sided tape, and the plurality of recesses are arranged in a spaced and staggered manner in the length direction of the double-sided tape.

Optionally, each of the recesses has an orthographic projection of a rectangle shape in the thickness direction, each recess penetrates the double-sided tape in the width direction thereof, and the plurality of recesses are arranged at intervals in the length direction of the double-sided tape.

Optionally, a plurality of first recesses on the first adhesive surface and a plurality of second recesses on the second adhesive surface are symmetrically arranged in the thickness direction of the double-sided tape.

Optionally, at least part of the plurality of first recesses are in communication with the corresponding second recesses.

Optionally, an elastic layer is disposed between the first adhesive surface and the second adhesive surface, in which bottoms of the plurality of recesses are located.

In a second aspect, there is provided a display device, including a liquid crystal panel and a backplane, wherein the display device further includes a bezel on the backplane, and the liquid crystal panel is adhered to the bezel via the double-sided tape according to the embodiments of the present application.

Optionally, the double-sided tape is a light-shielding tape.

Optionally, an elastic layer made of foam is arranged between the first adhesive surface and the second adhesive surface of the double-sided tape.

According to the technical solution provided in the embodiments of the present application, by means of the recesses arranged on the first adhesive surface and/or the second adhesive surface of the double-sided tape, the problem of accumulated stress in conventional double-sided tapes can be solved.

### BRIEF DESCRIPTION OF THE DRAWINGS

Other features, objects and advantages of the present application will become more apparent upon reading of the detailed description of non-limiting embodiments made with reference to the following drawings:

FIG. 1 shows an exemplary top view of a double-sided tape according to a first embodiment of the present application;

FIG. 2 shows a cross-sectional view of FIG. 1 along A1A2;

FIG. 3 shows an exemplary top view of a double-sided tape according to a second embodiment of the present application;

FIG. 4 shows a cross-sectional view of FIG. 1 along A1A2;

FIG. 5 shows an exemplary top view of a double-sided tape according to a third embodiment of the present application;

FIG. 6 shows a cross-sectional view of FIG. 4 along B1B2;

FIG. 7 shows an exemplary top view of a double-sided tape according to a fourth embodiment of the present application;

FIG. 8 shows a cross-sectional view of FIG. 4 along B1B2;

FIG. 9 shows an exemplary top view of a double-sided tape according to a fifth embodiment of the present application;

FIG. 10 shows a cross-sectional view of FIG. 7 along C1C2;

FIG. 11 shows an exemplary top view of a double-sided tape according to a sixth embodiment of the present application;

FIG. 12 shows a cross-sectional view of FIG. 8 along C1C2; and

FIG. 13 shows a partial cross-sectional view of a display device.

### DETAILED DESCRIPTION OF THE EMBODIMENTS

The present application will now be further described in detail below in conjunction with the drawings and exemplary embodiments. It will be appreciated that the specific embodiments described here are used only for the purpose of explaining the related disclosure instead of limiting the disclosure. It should be also noted that, for the convenience of description, only parts related to the disclosure are shown in the drawings.

Unless otherwise defined, technical or scientific terms used in the present disclosure are intended to have general meanings as understood by those of ordinary skill in the art. The words “first”, “second” and similar terms used in the present disclosure do not denote any order, quantity, or importance, but are used merely for distinguishing different components. The word “comprising” or “comprises” or the like means that the element or item preceding the word includes elements or items that appear after the word or equivalents thereof, but does not exclude other elements or items. The terms “connected” or “coupled” and the like are not restricted to physical or mechanical connections, but may include electrical connections, whether direct or indirect. The words “upper”, “lower”, “left”, “right”, or the like are merely used to indicate a relative positional relationship, and when an absolute position of the described object is changed, the relative positional relationship may also be changed accordingly.

It should be noted that the embodiments of the present application and features therein may be combined with each other in any manner as long as they are not contradictory. The present application will be described in detail below with reference to the drawings in conjunction with the embodiments.

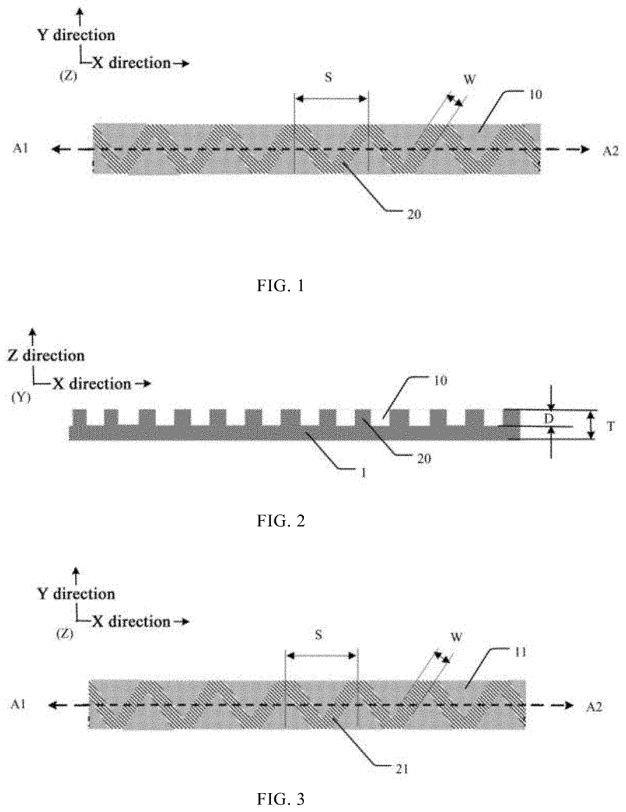

Referring to FIGS. 1 to 12, at least one embodiment of the present application provides a double-sided tape, including a first adhesive surface and a second adhesive surface disposed oppositely in a thickness direction; and

at least one of the first adhesive surface and the second adhesive surface of the double-sided tape is provided with a plurality of recesses 10.

The double-sided tape has a cuboid shape, and the adhesive surface is a surface of the double-sided tape in direct contact with an adhered object. Conventional double-sided tapes tend to produce stress that is continuously accumulated under the influence of factors such as self-deformation of the tape, fluctuations in the fitting precision, or the like. In the present application, however, the recesses 10 are arranged on at least one of the first adhesive surface and the second adhesive surface of the double-sided tape so that the stress is released into the recesses and thus the deformation risk of the adhered object is reduced.

In practical applications, the recesses may be arranged on the adhesive surface in a different manner, and the embodiments of the present application are schematically illustrated by taking the following six implementation manners as examples.

It should be noted that, for convenience of description, the drawings are provided with an X direction (X axis), a Y direction (Y axis), and a Z direction (Z axis), where the X direction is a length direction of the double-sided tape, the Y direction is a width direction of the double-sided tape, the Z direction is a thickness direction of the double-sided tape, and the three directions are pairwise orthogonal to each other.

Specifically, each recess 10 includes an opening along the Z axis and the Y axis, wherein the opening of each recess 10, along the Y axis, may be oriented in a positive direction of the Y axis, or in a negative direction of the Y axis, or both. Also, each of the recesses 10 may have an orthographic projection of a different shape in the thickness direction (along the Z axis). The orthographic projection here refers to an orthographic projection in the XY plane. The following description is made with reference to specific examples.

In a first practical embodiment as shown in FIGS. 1 and 2, each of the recesses 10 has an orthographic projection of a triangle shape, and the plurality of triangular recesses 10 are arranged in a spaced and staggered manner in the length direction of the double-sided tape. The “spaced and staggered manner” means that a certain distance exists between any two adjacent recesses 10 in the X direction, while orthogonal projections of the two recesses are staggered with each other in the Y direction. One side of the triangle is the opening of the recess 10 in the width direction of the double-sided tape. Therefore, from the perspective of the non-recessed areas in FIG. 1, the non-recessed areas form a pattern of: end-to-end V-shaped units 20 extending in the length direction. When the double-sided tape is used for adhering and fixing a display panel in a display device, the stress generated during adhesion and use can be released at the recesses 10 so that the light leakage defect at edges of the display area caused by accumulated stress is reduced, and normal display is achieved at the display edges. Orthographic projections of the recesses 10 are complementary to the orthographic projections of the V-shaped units 20, i.e. a sum of the orthographic projection areas of all the recesses 10 and the V-shaped units 20 coincides with (is equal to) the orthographic projection of the double-sided tape. It will be appreciated that each V-shaped unit may has a symmetrical structure as shown in FIG. 1, or has an asymmetrical structure, which can be set according to the requirements of the application scenario and is not limited herein.

In this embodiment, the recesses are provided on only one of the first adhesive surface and the second adhesive surface of the double-sided tape, as shown in FIG. 2. FIG. 2 is a cross-sectional view of FIG. 1 along A1A2. The length S, width W and thickness D of each V-shaped unit in the X direction, and the thickness T of the double-sided tape are not limited herein, and are specifically set according to the application scenario and a size of the double-sided tape. The width W is a distance W between adjacent surfaces of each V-shaped unit that are perpendicular to the XY plane and parallel to each other. These parameters should satisfy the following relations: width W of the V-shaped unit <length S of the V-shaped unit, and thickness T of the double-sided tape ≥thickness D of the V-shaped unit.

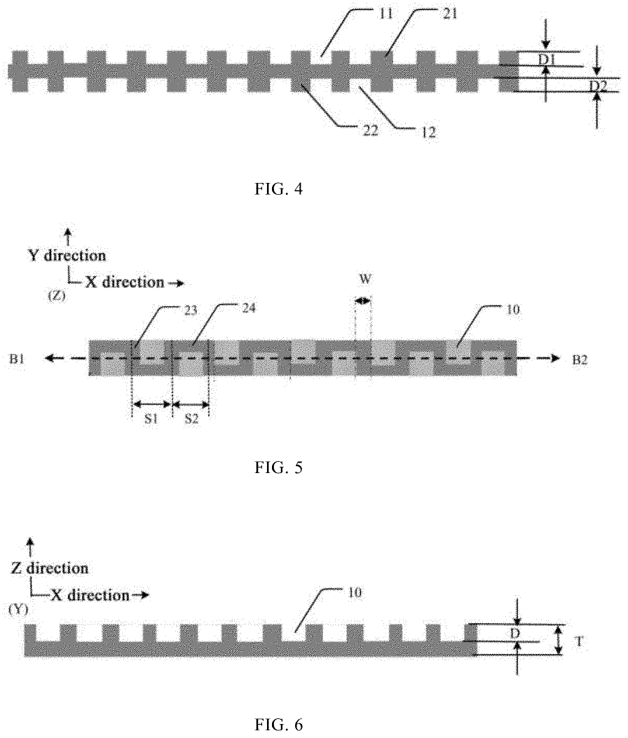

A second practical embodiment is shown in FIGS. 3 and 4. This embodiment differs from the first embodiment in that the recesses 10 are provided on both the first adhesive surface and the second adhesive surface of the double-sided tape, and first recesses on the first adhesive surface and second recesses on the second adhesive surface are symmetrically arranged to form the same pattern as that of FIG. 3, i.e., a pattern in which the end-to-end V-shaped units extend in the length direction, on the other surface of the double-sided tape. In this embodiment the recesses include first recesses 11 arranged on the first adhesive surface and second recesses 12 arranged on the second adhesive surface. Here, both the first adhesive surface and the second adhesive surface are perpendicular to the Z axis, a positive direction of the Z axis is upward, a negative direction of the Z axis is downward, and the first recesses 11 and the second recesses 12 are symmetrically arranged up and down. Correspondingly, the V-shaped units formed by the non-recessed areas include first V-shaped units 21 located on the first adhesive surface side and second V-shaped units 22 located on the second adhesive surface side, and the first V-shaped units 21 and the second V-shaped units 22 are symmetrically arranged up and down. The length S, width W and thickness D1 of each first V-shaped unit in the X direction, and the thickness T of the double-sided tape are not limited herein, and are specifically set according to the application scenario and a size of the double-sided tape. The length S, width W and thickness D2 of each second V-shaped unit in the X direction, and the thickness T of the double-sided tape are not limited herein, and are specifically set according to the application scenario and a size of the double-sided tape. These parameters should satisfy the following relations: width W<length S, and thickness T of the double-sided tape≥(thickness D1+thickness D2). When the double-sided tape is used for adhering and fixing a display panel in a display device, the stress generated during adhesion and use can be released at the recesses 11 and 12 on the two sides so that it is possible to better reduce deformation of the display panel caused by the accumulated stress at the adhesion position, thereby avoiding the problem of light leakage at edges in the dark state of the display screen.

In a third practical embodiment as shown in FIGS. 5 and 6, each of the recesses 10 has an orthographic projection of a rectangle shape in the thickness direction, and the plurality of rectangular recesses 10 are arranged in a spaced and staggered manner in the length direction of the double-sided tape. In other words, a certain distance exists between any two adjacent recesses 10 in the X direction, while orthogonal projections of the two recesses are staggered with each other in the Y direction. One side of the rectangle is the opening of the recess 10 in the width direction of the double-sided tape. As seen from the non-recessed areas of FIG. 5, the non-recessed areas have a pattern formed by “ [symbol] ” shaped units 23 and “ [symbol] ” shaped units 24 that are arranged alternatively and connected end to end, and the pattern extends in the length direction. When the double-sided tape is used for adhering and fixing a display panel in a display device, the stress generated during adhesion and use can be released at the recesses 10 so that the light leakage defect at edges of the display area caused by accumulated stress is reduced, and normal display is achieved at the display edges.

Orthographic projections of the recesses 10 are complementary to orthographic projections of the “ [symbol] ” shaped units 23 or the “ [symbol] ” shaped units 24 on the first adhesive surface, i.e. a sum of the orthographic projection areas of all the recesses, the “ [symbol] ” shaped units 23 and the “ [symbol] ” shaped units 24 coincides with (is equal to) the orthographic projection of the double-sided tape. It will be appreciated that a length S1 of each “ [symbol] ” shaped unit along the X-direction or a length S2 of each “ [symbol] ” shaped unit along the X-direction may be the same or different, and are not limited herein.

In this embodiment, the recesses are provided on only one of the adhesive surfaces of the double-sided tape, as shown in FIGS. 5 and 6. The length S1 or S2, width W and thickness D of each “ [symbol] ” shaped unit or “ [symbol] ” shaped unit along the X direction, and the thickness T of the double-sided tape are not limited herein, and are specifically set according to the application scenario and a size of the double-sided tape. The width W is a distance W between adjacent surfaces of each “ [symbol] ” shaped unit or “ [symbol] ” shaped unit that are perpendicular to the XY plane and parallel to each other. These parameters should satisfy the following relations: width W<length S, and thickness T of the double-sided tape≥thickness D.

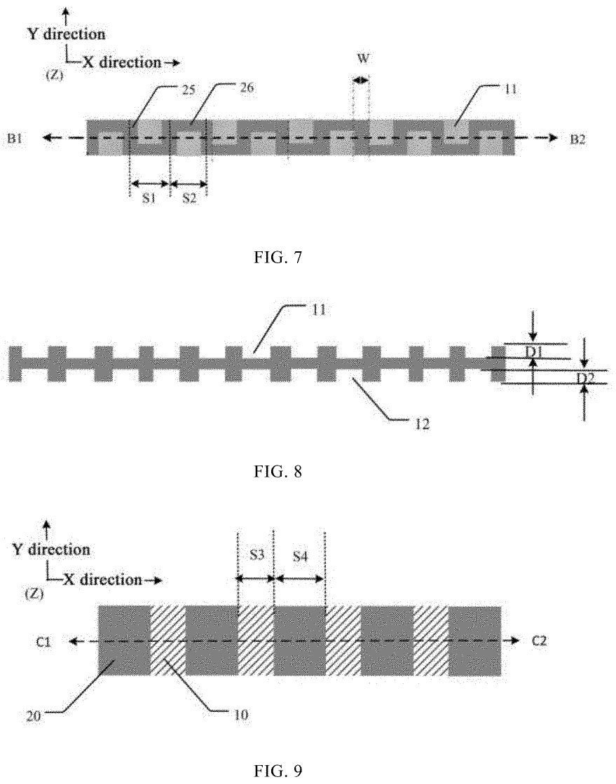

A fourth practical embodiment is shown in FIGS. 7 and 8. This embodiment differs from the third embodiment in that the recesses are provided on both the first adhesive surface and the second adhesive surface of the double-sided tape, and first recesses on the first adhesive surface and second recesses on the second adhesive surface are symmetrically arranged. The same pattern as that of FIG. 7, i.e., a pattern in which the “ [symbol] ” shaped units and the “ [symbol] ” shaped units are connected end to end and extend in the length direction, is formed on the other surface of the double-sided tape. In this embodiment the recesses include first recesses 11 arranged on the first adhesive surface and second recesses 12 arranged on the second adhesive surface, and the first recesses 11 and the second recesses 12 are symmetrically arranged up and down. Correspondingly, the “ [symbol] ” shaped units include first “ [symbol] ” shaped units 25 provided on the first adhesive surface and second “ [symbol] ” shaped units (not shown) provided on the second adhesive surface, and the first “ [symbol] ” shaped units 25 and the second “ [symbol] ” shaped units are symmetrically arranged up and down. The length S1, width W and thickness D1 in the X direction of each first “ [symbol] ” shaped unit 25 on the first adhesive surface, and the thickness T of the double-sided tape are not limited herein, and are specifically set according to the application scenario and a size of the double-sided tape. The length S1, width W and thickness D2 in the X direction of each second “ [symbol] ” shaped unit, and the thickness T of the double-sided tape are not limited herein, and are specifically set according to the application scenario and a size of the double-sided tape. These parameters should satisfy the following relations: width W<length S1, and thickness T of the double-sided tape (thickness D1 +thickness D2). Likewise, the “ [symbol] ” shaped units include first “ [symbol] ” shaped units 26 provided on the first adhesive surface and second “ [symbol] ” shaped units provided on the second adhesive surface, and the first “ [symbol] ” shaped units 26 and the second “ [symbol] ” shaped units are symmetrically arranged up and down. The length S2, width W and thickness D1 in the X direction of each first “ [symbol] ” shaped unit 26 provided on the first adhesive surface, and the thickness T of the double-sided tape are not limited herein, and are specifically set according to the application scenario and a size of the double-sided tape. The length S2, width W and thickness D2 in the X direction of each second “ [symbol] ” shaped unit provided on the second adhesive surface, and the thickness T of the double-sided tape are not limited herein, and are specifically set according to the application scenario and a size of the double-sided tape. These parameters should satisfy the following relations: width W<length S2, and thickness T of the double-sided tape≥(thickness D1 +thickness D2). When the double-sided tape is used for adhering and fixing a display panel in a display device, the stress generated during adhesion and use can be released at the recesses 11 and 12 on the two sides so that it is possible to better reduce deformation of the display panel caused by the accumulated stress at the adhesion position, thereby avoiding the problem of light leakage at edges in the dark state of the display screen.

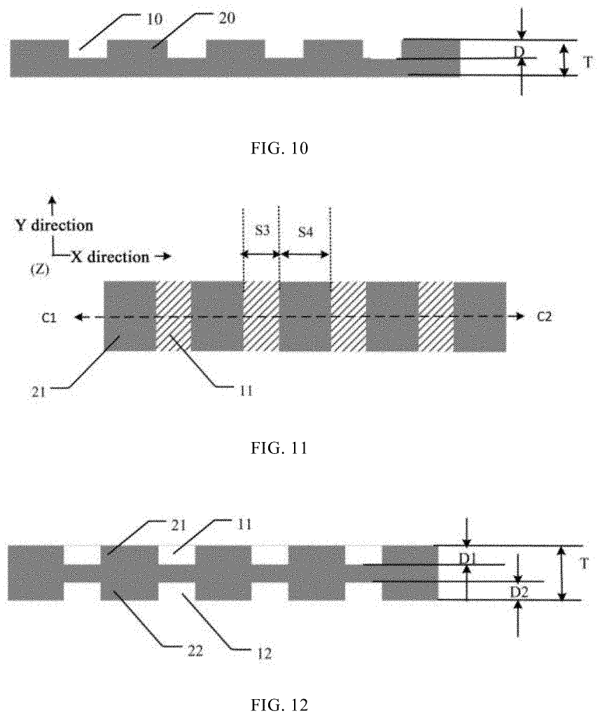

A fifth practical embodiment is shown in FIGS. 9 and 10, where FIG. 10 is a cross-sectional view of FIG. 9 along C1C2. Each of the recesses 10 has an orthographic projection of a rectangle shape in the thickness direction, and the plurality of recesses 10 are arranged in a spaced manner in the length direction X of the double-sided tape, and the recesses 10 penetrates the double-sided tape along the Y axis, that is, the opening of each recess 10 along the Y axis faces both the positive and negative directions of the Y axis. In this embodiment, the recesses 10 and non-recessed units 20 are arranged alternatively and extend in the length direction. When the double-sided tape is used for adhering and fixing a display panel in a display device, the stress generated during adhesion and use can be released at the recesses 10 so that the light leakage defect at edges of the display area caused by accumulated stress is reduced, and normal display is achieved at the display edges. It will be appreciated that a length S3 of each recess 10 along the X direction and a length S4 of each non-recessed unit 20 along the X direction may be the same or different, and are not limited herein.

In this embodiment, the recesses are provided on one adhesive surface of the double-sided tape, as shown in FIG. 10. The thickness D of each recess, and the thickness T of the double-sided tape are not limited herein, and are specifically set according to the application scenario and a size of the double-sided tape. These parameters should satisfy the following relations: thickness T of the double-sided tape recess thickness D.

A sixth practical embodiment is shown in FIGS. 11 and 12, where FIG. 12 is a cross-sectional view of FIG. 11 along C1C2. This embodiment differs from the fifth embodiment in that the recesses are provided on both the first adhesive surface and the second adhesive surface of the double-sided tape, and first recesses on the first adhesive surface and second recesses on the second adhesive surface are symmetrically arranged to form the same pattern as that of FIG. 11, i.e., a pattern in which the recesses 11 and the non-recessed units 21 are alternatively arranged and extend in the length direction, on the other surface of the double-sided tape. In this embodiment the recesses include first recesses 11 arranged on the first adhesive surface and second recesses 12 arranged on the second adhesive surface, and the first recesses 11 and the second recesses 12 are symmetrically arranged up and down. Correspondingly, the non-recessed units include first non-recessed units 21 provided on the first adhesive surface and second non-recessed units 22 provided on the second adhesive surface, and the first non-recessed units 21 and the second non-recessed units 22 are symmetrically arranged up and down. The thickness D1 of each first recess provided on the first adhesive surface and the thickness D2 of each second recess are specifically set according to the application scenario and a size of the double-sided tape. These parameters should satisfy the following relations: thickness T of the double-sided tape (thickness D1 of the first recess+thickness D2 of the second recess). When the double-sided tape is used for adhering and fixing a display panel in a display device, the stress generated during adhesion and use can be released at the recesses 11 and 12 on the two sides so that it is possible to better reduce deformation of the display panel caused by the accumulated stress at the adhesion position, thereby avoiding the problem of light leakage at edges in the dark state of the display screen.

the above each embodiment, an elastic layer is arranged between the first adhesive surface and the second adhesive surface of the double-sided tape, in which bottoms of the recesses are located. The elastic layer may be made of foam.

Optionally, at least part of the plurality of first recesses are in communication with the corresponding second recesses, i.e., part of the first recesses and the second recesses form a through channel in the thickness direction. Thereby, manufacture of the recesses is facilitated and mass of the double-sided tape is reduced.

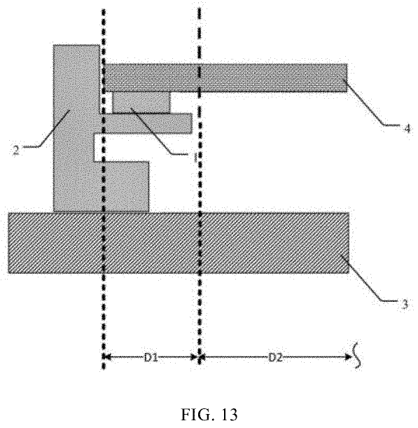

As shown in FIG. 13, the present application further discloses a display device, including a liquid crystal panel 4 and a backplane 3. The display device further includes a bezel 2 on the backplane 3, and the liquid crystal panel 4 is fixed to the bezel 2 via the double-sided tape 1 according to the embodiments of the present application. The shape of the bezel is not limited here, and may be any shape that can fix the liquid crystal panel. The liquid crystal panel of the present application includes a non-display area D1 and a display area D2, and it should be noted that FIG. 13 provides only a partial view of the display device, and thus the other end of the display area D2 is indicated by a curved line.

Optionally, the double-sided tape applied to the display device is a light-shielding tape, and specifically, the foam of the double-sided tape may be black foam.

The above description illustrates only preferred embodiments of the present application and technical principles applied therein. It will be appreciated by those skilled in the art that the disclosure scope of the present application is not limited to the technical solutions formed by specific combinations of the above technical features, but shall cover any other technical solution formed by any combination of the above technical features or equivalent features thereof without departing from the above inventive concepts. For example, the above features may be replaced with (but not limited to) features having similar functions disclosed in the present application.

What is claimed is:

1. A double-sided tape, wherein the double-sided tape comprises a first adhesive surface and a second adhesive surface disposed oppositely in a thickness direction; and
at least one of the first adhesive surface and the second adhesive surface of the double-sided tape is provided with a plurality of recesses.

2. The double-sided tape according to claim 1, wherein each of the plurality of recesses has an opening in a thickness direction and a width direction of the double-sided tape, wherein the opening of each recess, in the width direction of the double-sided tape, is open to at least one side of the width direction, and the double-sided tape extends in a length direction.

3. The double-sided tape according to claim 2, wherein each of the recesses has an orthographic projection of a triangle shape in the thickness direction, one side of the triangle is the opening of each recess in the width direction of the double-sided tape, and the plurality of recesses are arranged in a spaced and staggered manner in the length direction of the double-sided tape.

4. The double-sided tape according to claim 2, wherein each of the recesses has an orthographic projection of a rectangle shape in the thickness direction, one side of the rectangle is the opening of each recess in the width direction of the double-sided tape, and the plurality of recesses are arranged in a spaced and staggered manner in the length direction of the double-sided tape.

5. The double-sided tape according to claim 2, wherein each of the recesses has an orthographic projection of a rectangle shape in the thickness direction, each recess penetrates the double-sided tape in the width direction thereof, and the plurality of recesses are arranged at intervals in the length direction of the double-sided tape.

6. The double-sided tape according to claim 1, wherein a plurality of first recesses on the first adhesive surface and a plurality of second recesses on the second adhesive surface are symmetrically arranged in the thickness direction of the double-sided tape.

7. The double-sided tape according to claim 6, wherein at least part of the plurality of first recesses are in communication with the corresponding second recesses.

8. The double-sided tape according to claim 1, wherein an elastic layer is disposed between the first adhesive surface and the second adhesive surface, in which bottoms of the plurality of recesses are located.

9. A display device, comprising a liquid crystal panel and a backplane, wherein the display device further comprises a bezel on the backplane, and the liquid crystal panel is adhered to the bezel via the double-sided tape of claim 1.

10. The display device according to claim 9, wherein the double-sided tape is a light-shielding tape.

11. The display device according to claim 9, wherein an elastic layer made of foam is arranged between the first adhesive surface and the second adhesive surface of the double-sided tape.
